(19) United States
(12) Patent Application Publication
(10) Pub. No.: US 2025/0246738 A1
(43) Pub. Date: Jul. 31, 2025

(54) HOUSING APPARATUS

(71) Applicant: TOYOTA JIDOSHA KABUSHIKI KAISHA, Toyota-shi (JP)

(72) Inventors: Yasuhiro KURODA, Toyota-shi (JP); Kai MIYAMURA, Toyota-shi (JP)

(73) Assignee: TOYOTA JIDOSHA KABUSHIKI KAISHA, Toyota-shi (JP)

(21) Appl. No.: 18/981,856

(22) Filed: Dec. 16, 2024

(30) Foreign Application Priority Data
Jan. 31, 2024 (JP) 2024-012963

(51) Int. Cl. H01M 50/249; H01M 50/202; H01M 50/271

(52) U.S. Cl. CPC H01M 50/249; H01M 50/202; H01M 50/271; H01M 2220/20

(57) ABSTRACT

A housing apparatus according to the present disclosure is a housing apparatus for housing a replaceable battery, including: a cabinet having a housing space and an opening part that allows the housing space to open to the outside of the housing apparatus in a front-end part; a lid part provided in the opening part so as to be openable and closable between the housing space and the outside of the housing apparatus; a connector provided in a rear-end part of the cabinet in a connectable manner with the connector of the replaceable battery in the housing space of the cabinet; a first member configured to move in response to the opening and closing of the lid part; and a pressing member configured to move in response to the movement of the first member thereby pressing a side surface of the replaceable battery housed in the housing space of the cabinet.

### CROSS REFERENCE TO RELATED APPLICATIONS

This application is based upon and claims the benefit of priority from Japanese patent application No. 2024-012963, filed on Jan. 31, 2024, the disclosure of which is incorporated herein in its entirety by reference.

### BACKGROUND

The present disclosure relates to a housing apparatus.

Patent Literature 1 discloses a vehicle in which a detachable replaceable battery is installed.
Patent Literature 1: Japanese Unexamined Patent Application Publication No. 2019-84843

### SUMMARY

A housing space in a housing apparatus for housing a replaceable battery, needs to be provided with a sufficient clearance to facilitate loading and unloading of the replaceable battery in and from the housing space. However, in this case, there is a problem that since the replaceable battery housed in the housing apparatus is not fixed and is therefore unstable, the replaceable battery sways due to an external vibration or the like, and as a result, stress is concentrated at the connecting part between a connector of the replaceable battery and a connector of the housing apparatus.

The present disclosure has been made in view of the above background, and it is an object of the present disclosure to provide a housing apparatus capable of suppressing concentration of stress at a connecting part connecting the housing apparatus and a replaceable battery.

A housing apparatus for housing a replaceable battery for supplying electric power to a vehicle, including: a cabinet having a housing space in which the replaceable battery is housed and an opening part that allows the housing space to open to the outside of the housing apparatus in a front-end part; a lid part provided in the opening part so as to be openable and closable between the housing space and the outside of the housing apparatus; a connector provided in a rear-end part of the cabinet in a connectable manner with the connector of the replaceable battery in the housing space of the cabinet; a first member configured to move in response to the opening and closing of the lid part; and a pressing member configured to move in response to the movement of the first member thereby pressing a side surface of the replaceable battery housed in the housing space of the cabinet. Even if the housing space is provided with a sufficient clearance to facilitate loading and unloading of the replaceable battery in and out from the housing space, the replaceable battery housed in the housing space can be fixed by using the pressing member which is configured to move in response to the opening and closing of the lid part, and therefore the concentration of stress at the connecting part between the housing space and the replaceable battery can be suppressed.

The first member may be configured to project from the housing space of the cabinet to the outside of the cabinet via the opening part when the lid part is opened, and to be pushed into the housing space of the cabinet by the lid part from the projected state when the lid part is closed. By having the first member move in response to the opening and closing of the lid part due to physical contact between the first member and the lid part, it is possible to suppress concentration of stress at the connector due to an external vibration while maintaining the workability of the detachable replaceable battery without increasing the size of the replaceable battery or the housing apparatus.

The housing apparatus may further include a spring for relieving pressing by the pressing member on the replaceable battery when the lid part is opened. With a simple configuration, pressing by the pressing member on the replaceable battery can be relieved, and the replaceable battery can be easily taken out from the housing space.

The spring may be provided for applying a tension in a direction opposite to a pressing direction in which the pressing member presses the replaceable battery when the lid part is closed. With a simple configuration, pressing by the pressing member on the replaceable battery can be relieved, and the replaceable battery can be easily taken out from housing space.

The housing apparatus may further include a second pressing member provided inside the lid part for pressing the front-end part of the replaceable battery stored in the housing space of the cabinet when the lid part is closed. Since the replaceable battery housed in the housing space can be fixed more stably by the second pressing member, concentration of stress at the connecting part between the replaceable battery and housing apparatus can be suppressed.

According to the present disclosure, it is possible to provide a housing apparatus capable of suppressing concentration of stress at the connecting part connecting the housing apparatus and a replaceable battery.

The above and other objects, features and advantages of the present disclosure will become more fully understood from the detailed description given hereinbelow and the accompanying drawings.

### BRIEF DESCRIPTION OF DRAWINGS

FIG. 1 is a schematic perspective view showing an external appearance of a replaceable battery to be housed in a housing apparatus according to a first embodiment;

FIG. 2 is an enlarged schematic perspective view of the periphery of a front-end part of the replaceable battery shown in FIG. 1;

FIG. 3 is an enlarged schematic perspective view of the periphery of a rear-end part of the replaceable battery shown in FIG. 1;

FIG. 4 is a schematic perspective view showing an external appearance of the housing apparatus according to the first embodiment;

FIG. 5 is a schematic cross-sectional view of the housing apparatus according to the first embodiment;

FIG. 6 is a schematic cross-sectional view for describing the flow of housing a replaceable battery in a housing apparatus according to the first embodiment; and

FIG. 7 is a schematic cross-sectional view of the housing apparatus according to the first embodiment.

### DESCRIPTION OF EMBODIMENTS

Hereinafter, the present disclosure will be described through embodiments of the present disclosure, but the embodiments are not intended to limit the scope of the present disclosure according to the claims. Further, not all of the configurations described in the embodiments are essential as means for solving the problem.

For clarity of explanation, the following description and drawings are omitted and simplified as appropriate. In the drawings, the same elements are denoted by the same reference numerals, and redundant explanations are omitted as necessary.

### First Embodiment

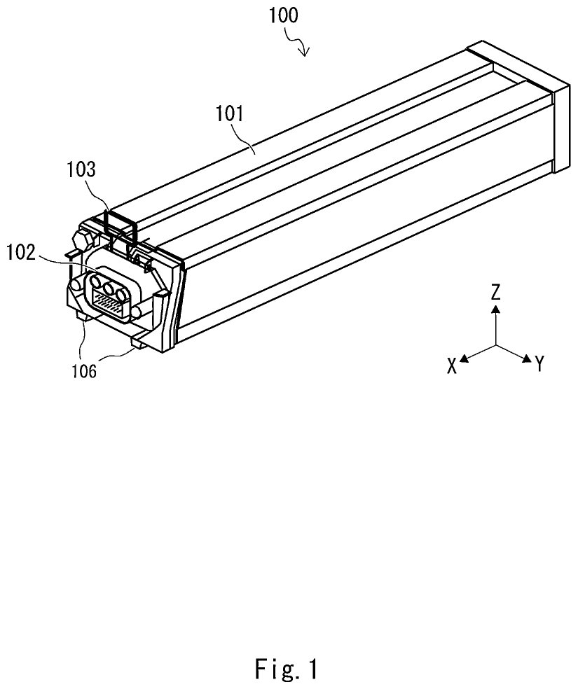

FIG. 1 is a schematic perspective view showing an external appearance of a replaceable battery 100 to be housed in a housing apparatus 1 according to a first embodiment. The replaceable battery 100 is also referred to as a battery pack, a battery module, or the like, and is detachably installed in the housing apparatus 1 installed in a vehicle such as a battery electric vehicle that travels by means of a motor using electric power as a power source. The replaceable battery 100 is reduced in size and weight so that, for example, an operator can easily insert and remove the replaceable battery 100 into and from the housing apparatus 1 of a battery electric vehicle. Examples of an operator include a working robot and the like.

As shown in FIG. 1, the outer shape of the replaceable battery 100 is defined in a rectangular parallelepiped shape by a case 101 for housing a cell stack or the like made of a plurality of battery cells. A connector 102 is provided on a rear-end part (rear case) of the replaceable battery 100 so as to project outward and be connectable to a connector of the housing apparatus 1 side (the vehicle side). A rail 106 extending in the longitudinal direction (the X-axis direction) of the replaceable battery 100 is provided on a bottom surface of the replaceable battery 100.

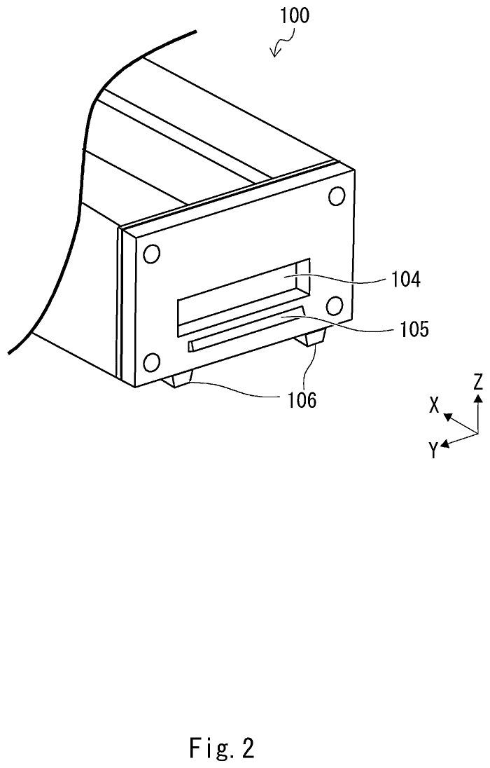

FIG. 2 is an enlarged schematic perspective view of the periphery of a front-end part (front case) of the replaceable battery 100. As shown in FIG. 2, a pull-handle 104 is provided on a front-end part of the replaceable battery 100. An operator holds the pull-handle 104 and pushes or pulls the replaceable battery 100, whereby allowing the replaceable battery 100 to be slid. A damper 105 is provided on a front-end part of the replaceable battery 100 so as to project outward.

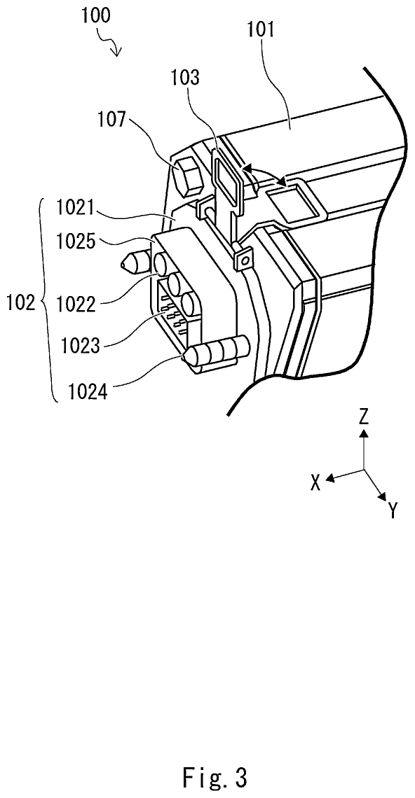

FIG. 3 is an enlarged schematic perspective view of the periphery of a rear-end part (a rear case) of the replaceable battery 100. As shown in FIG. 3, in addition to the connector 102, a grip-handle 103 and a relief valve 107 are provided on the rear-end part of the replaceable battery 100.

The connector 102 includes a base part 1021, a high-voltage terminal 1022, a low-voltage terminal 1023, an alignment pin 1024, and a metal cover 1025. The base part 1021 is disposed on the main surface of rear-end part (rear case) of the replaceable battery 100. The high-voltage terminal 1022, the low-voltage terminal 1023, and the alignment pin 1024 are all formed to project outward from the main surface of the base part 1021. The cover 1025 is formed to surround the side surfaces of the high-voltage terminal 1022 and the low-voltage terminal 1023. The high-voltage terminal 1022 is a terminal for transmitting electric power output from the cell stack housed in the case 101 of the replaceable battery 100 to a vehicle in which the replaceable battery 100 is installed. The low-voltage terminal 1023 is a terminal for transmitting a control signal from the vehicle to the replaceable battery 100 and transmitting a signal representing a monitoring result (voltage measurement result, etc.) of the cell stack from the replaceable battery 100 to the vehicle.

The relief valve 107 discharges gas generated in the cell stack housed in the case 101 of the replaceable battery 100. Here, even when gas is discharged from the relief valve 107, the high-voltage terminal 1022 and the low-voltage terminal 1023 are protected by the metal cover 1025.

The grip-handle 103 is rotatably provided about an axis extending along the upper edge of the rear-end part of the replaceable battery 100, and is placed on the upper surface of the case 101 when not in use. The replaceable battery 100 can be carried hanging it using the grip-handle 103 without causing any obstruction in the connection of the connector 102.

More specifically, when carrying the replaceable battery 100, an operator holds the rotatable grip-handle 103 with one hand to lift the replaceable battery 100, and holds the pull-handle 104 with the other hand to support the replaceable battery 100. Thus, an operator can carry the replaceable battery 100 while stabilizing the center of gravity (maintaining balance).

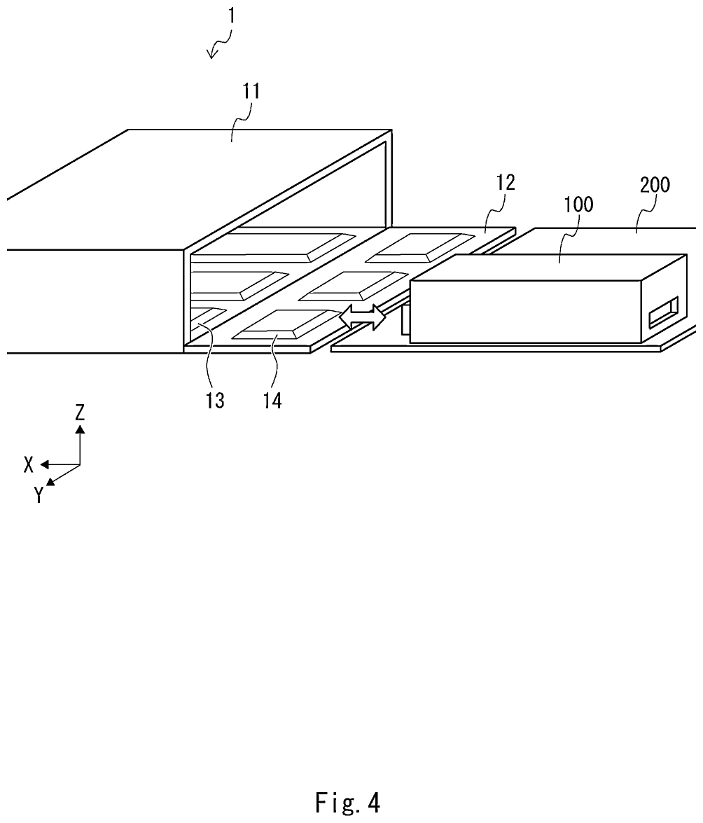

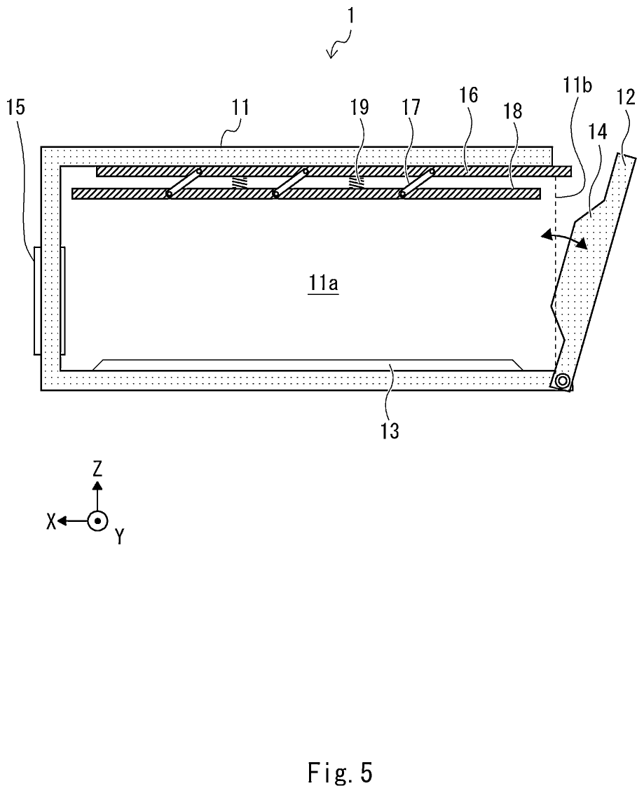

FIG. 4 is a schematic perspective view showing an external appearance of the housing apparatus 1 according to the present embodiment. FIG. 4 also shows the replaceable battery 100. FIG. 5 is a schematic cross-sectional view of the housing apparatus 1 as seen from the side surface (i.e., in the Y-axis direction). The housing apparatus 1 is installed in a vehicle and houses the replaceable battery 100 for supplying electric power to the vehicle. Specifically, the housing apparatus 1 includes at least a cabinet 11, a lid part 12, and a connector 15.

The cabinet 11 has a housing space 11a in which the replaceable battery 100 is housed, and an opening part 11b that allows the housing space 11a to open to the outside of the housing apparatus 1 in the front-end part. The connector 15 is provided in a rear-end part of the cabinet 11 in a connectable with the connector 102 of the replaceable battery 100 housed in the housing space 11a. The connector 15 projects outward from the rear-end part of the cabinet 11 and is connected to a vehicle (not shown).

The lid part 12 is provided in the opening part 11b of the cabinet 11 so as to be openable and closable between the housing space 11a and the outside of the housing apparatus 1. Specifically, the lid part 12 is provided so as to be rotatable about an axis extending along the lower edge of the opening part 11b of the cabinet 11.

When the lid part 12 is opened, the bottom surface in the housing space 11a of the cabinet 11 and the inner surface of the lid part 12 are positioned on the same plane (XY-plane). Guides 13 and 14 corresponding to the rails 106 of the replaceable battery 100 are provided on the bottom surface in the housing space 11a of the cabinet 11 and the inner surface of the lid part 12, respectively. For example, when an operator pushes the pull-handle 104 of the replaceable battery 100, the replaceable battery 100 slides in the longitudinal direction (the X-axis direction) along the guides 13 and 14 provided in the housing apparatus 1 and is housed in the housing space 11a of the housing apparatus 1. The connector 102 of the replaceable battery 100 housed in the housing space 11a of the housing apparatus 1 is connected to the connector 15 of the housing apparatus 1.

The replaceable battery 100 can be transported, for example, by being placed on a carriage 200. When the replaceable battery 100 is housed in the housing apparatus 1 from the carriage 200, the height of the carriage 200 is made equal to the housing apparatus 1, and the pull-handle 104 is pushed to house the replaceable battery 100 in the housing apparatus 1. On the other hand, when the replaceable battery 100 is taken out of the housing apparatus 1 and placed on the carriage 200, the height of the carriage is made equal to the housing apparatus 1, and the replaceable battery 100 is taken out of the housing apparatus 1 by pulling the pull-handle 104.

The housing apparatus 1 further includes a first member 16, a connecting member 17, a pressing member 18, and a spring 19. The first member 16 is a flat plate member and is provided along an upper surface inside the housing space 11a of the cabinet 11. The first member 16 is configured such that one end part thereof is projected from the opening part 11b. When the lid part 12 is closed, the lid part 12 presses one end part of the first member 16, and the first member 16 is pushed into the housing space 11a of the cabinet 11. That is, the first member 16 moves in the horizontal direction (the X-axis direction) in response to the opening and closing of the lid part 12. The pressing member 18 is a flat plate member and is connected to the first member 16 via the connecting member 17. The pressing member 18 moves in the vertical direction (the Z-axis direction) in response to the movement of the first member 16 in the horizontal direction (the X-axis direction). Specifically, when the lid part 12 is closed and the first member 16 is pushed into the housing space 11a of the cabinet 11, the pressing member 18 moves in the vertically-downward direction (the Z-axis negative direction). On the other hand, when the lid part 12 is opened, the pressing member 18 is lifted in the vertical direction (the Z-axis positive direction) by the spring 19 provided between the first member 16 and the pressing member 18, and a part of the first member 16 is pushed out from the housing space 11a of the cabinet 11 through the opening part 11b. That is, the spring 19 is configured such that a tension is applied in the direction opposite to the pressing direction (the Z-axis negative direction) in which the pressing member 18 presses the replaceable battery 100 when the lid part 12 is closed. By causing the first member 16 to move in response to the opening and closing of the lid part 12 due to the physical contact between the first member 16 and the lid part 12, it is possible to suppress concentration of stress at a connector due to an external vibration while maintaining the detachable workability of the replaceable battery 100 without increasing the sizes of the replaceable battery 100 and the housing apparatus 1.

Although not shown, an exhaust port for discharging the gas discharged from the relief valve 107 of the replaceable battery 100 to the outside through the vehicle is provided on a wall surface of the housing space 11a of the housing apparatus 1 facing the rear-end part (the rear case) of the replaceable battery 100. The gas discharged from the relief valve 107 of the replaceable battery 100 is discharged to the outside of the vehicle from, for example, the lower side of the vehicle through a duct connected to the exhaust port. Therefore, even if the gas is discharged from the relief valve 107 of the replaceable battery 100 housed in the housing apparatus 1, the gas does not circulate to the operator side, thereby ensuring the safety of the operator.

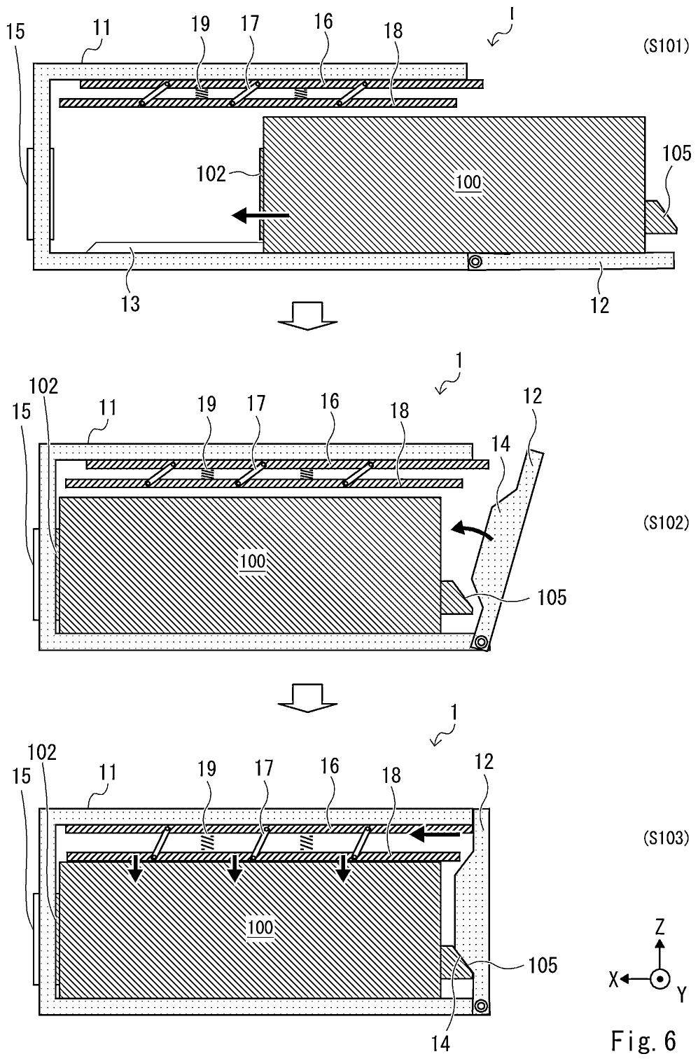

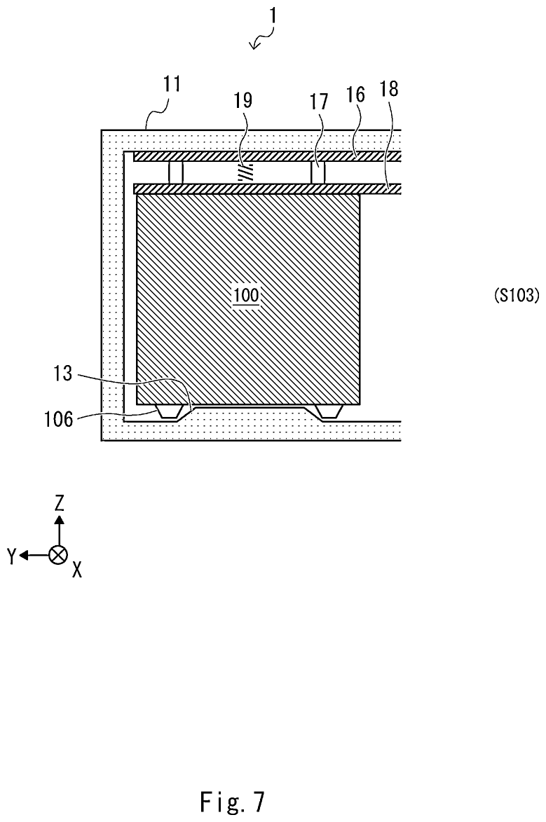

Next, a flow of housing the replaceable battery 100 in the housing apparatus 1 installed in the vehicle will be described with reference to FIGS. 6 and 7. FIG. 6 is a schematic cross-sectional view for describing the flow of housing the replaceable battery 100 in the housing apparatus 1. FIG. 7 is a schematic cross-sectional view of the housing apparatus 1 in which the replaceable battery 100 is housed. FIG. 6 is a schematic cross-sectional view of the housing apparatus 1 as seen from the side surface (i.e., in the Y-axis direction), and FIG. 7 is a schematic cross-sectional view of the housing apparatus 1 as seen from the front (i.e., in the X-axis direction).

First, when the lid part 12 of the housing apparatus 1 is opened, an operator pushes the front-end part of the replaceable battery 100 disposed near the opening part 11b of the housing apparatus 1, so that the replaceable battery 100 slides into the housing space 11a of the housing apparatus 1 along the guides 13 and 14 provided on the bottom surface of the housing space 11a of the housing apparatus 1 and the inner surface of the lid part 12 (Step S101 in FIG. 6).

Then, when the replaceable battery 100 is housed in the housing space 11a of the housing apparatus 1, the connector 102 of the replaceable battery 100 and the connector 15 on the housing apparatus 1 side are connected in the housing space 11a (Step S102 in FIG. 6). Then, the lid part 12 is closed.

When the lid part 12 is closed, one end part of the first member 16 is pressed by the lid part 12, and the first member 16 is pushed into the housing space 11a of the cabinet 11. As the first member 16 is pushed into the housing space 11a of the cabinet 11, the pressing member 18 moves in the vertically-downward direction (the Z-axis negative direction). That is, the pressing member 18 presses the side surface of the replaceable battery 100 housed in the housing space 11a of the housing apparatus 1 from above (Step S103 in FIGS. 6 and 7). As a result, the replaceable battery 100 is fixed at the housing space 11a of the housing apparatus 1.

When the lid part 12 is closed, the guide 14 formed on the inner surface of the lid part 12 presses the damper 105 of the replaceable battery 100. As a result, the replaceable battery 100 is fixed more stably in the housing space 11a of the housing apparatus 1. Preferably, the damper 105 of the replaceable battery 100 has an inclined surface facing obliquely upward at the housing space 11a of the housing apparatus 1, and the guide 14 formed on the inner surface of the lid part 12 has an inclined surface facing obliquely downward at the bottom surface of the housing space 11a when the lid part 12 is closed. As a result, the damper 105 of the replaceable battery 100 is also pressed in the downward direction by the guide 14, and the replaceable battery 100 is fixed more stably in the housing space 11a of the housing apparatus 1.

As described above, in the housing apparatus 1 according to the present disclosure, even if the housing space 11a is provided with a sufficient clearance to facilitate loading and unloading of the replaceable battery 100 in and from the housing space 11a, the replaceable battery 100 housed in the housing space 11a can be fixed by using the pressing member 18 which is configured to move in response to the opening and closing of the lid part 12, and therefore, the concentration of stress at the connecting part between the housing space 11a and the replaceable battery 100 can be suppressed.

The present disclosure is not limited to the embodiments described above, and may be appropriately modified without departing from the gist of the present disclosure.

For example, the pressing member 18 is not limited to a flat plate member, and may be a balloon-shaped member configured to move in response to the movement of the first member 16 to thereby adjust the amount of gas therein. For example, when the lid part 12 is closed, the balloon-shaped member inflates to press the replaceable battery 100 housed in the housing space 11a of the housing apparatus 1. On the other hand, when the lid part 12 is opened, the balloon-shaped member deflates, thereby the replaceable battery 100 housed in the housing space 11a of the housing apparatus 1 is relieved from being pressed.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A housing apparatus for housing a replaceable battery for supplying electric power to a vehicle, comprising:
a cabinet having a housing space in which the replaceable battery is housed and an opening part that allows the housing space to open to the outside of the housing apparatus in a front-end part;
a lid part provided in the opening part so as to be openable and closable between the housing space and the outside of the housing apparatus;
a connector provided in a rear-end part of the cabinet in a connectable manner with the connector of the replaceable battery in the housing space of the cabinet;
a first member configured to move in response to the opening and closing of the lid part; and
a pressing member configured to move in response to the movement of the first member thereby pressing a side surface of the replaceable battery housed in the housing space of the cabinet.

2. The housing apparatus according to claim 1, wherein the first member is configured to project from the housing space of the cabinet to the outside of the cabinet via the opening part when the lid part is opened, and to be pushed into the housing space of the cabinet by the lid part from the projected state when the lid part is closed.

3. The housing apparatus according to claim 1, further comprising a spring for relieving pressing by the pressing member on the replaceable battery when the lid part is opened.

4. The housing apparatus according to claim 3, wherein the spring is provided for applying a tension in a direction opposite to a pressing direction in which the pressing member presses the replaceable battery when the lid part is closed.

5. The housing apparatus according to claim 1, further comprising a second pressing member provided inside the lid part for pressing the front-end part of the replaceable battery stored in the housing space of the cabinet when the lid part is closed.
